(19) United States
(12) Patent Application Publication
(10) Pub. No.: US 2019/0187545 A1
(43) Pub. Date: Jun. 20, 2019

(54) WAVELENGTH CONVERSION ELEMENT, LIGHT SOURCE APPARATUS, AND PROJECTOR

(71) Applicant: SEIKO EPSON CORPORATION, Tokyo (JP)

(72) Inventor: Osamu ARAKAWA, Shiojiri-shi (JP)

(73) Assignee: SEIKO EPSON CORPORATION, Tokyo (JP)

(21) Appl. No.: 16/221,668

(22) Filed: Dec. 17, 2018

(30) Foreign Application Priority Data
Dec. 18, 2017 (JP) 2017-241908

(51) Int. Cl. G03B 21/20; H04N 9/31; G03B 33/12

(52) U.S. Cl. CPC G03B 21/204; H04N 9/3164; G03B 33/12; G03B 21/2066; H04N 9/3161

(57) ABSTRACT

A wavelength conversion element includes a wavelength conversion layer having a first surface on which excitation light is incident and a second surface provided on the side opposite the first surface, the wavelength conversion layer wavelength-converting the excitation light into converted light having a wavelength longer than the wavelength of the excitation light, a scattering element contained in the wavelength conversion layer and having a size smaller than or equal to the wavelength of the excitation light, and an incident angle changing section that changes the angle of incidence of the converted light with respect to the first surface or the second surface.

### BACKGROUND

### 1. Technical Field

The present invention relates to a wavelength conversion element, a light source apparatus, and a projector.

### 2. Related Art

JP-A-2013-30380 discloses an illuminator that irradiates a phosphor with excitation light to produce fluorescence and uses the produced fluorescence as illumination light. In the illuminator, the phosphor contains scatterer particles that cause Rayleigh scattering or cause only the excitation light to be scattered. Fluorescence conversion efficiency of conversion of the excitation light into the fluorescence is thus improved.

JP-A-2014-186882 discloses a technology of a reflective wavelength conversion element in which the density of scatterers is higher on the side facing a base that supports a phosphor than on the side close to the light incident and emitting surface of the phosphor for prevention of occurrence of temperature quenching of the phosphor and improvement in fluorescence extraction efficiency.

In the invention disclosed in JP-A-2013-30380 described above, however, since the fluorescence is unlikely to be scattered, some of the fluorescence does not exit out of the phosphor. As a result, the fluorescence extraction efficiency undesirably decreases.

In the invention disclosed in JP-A-2014-186882 described above, the phosphor absorbs a large amount of excitation light on the side facing the base where the excitation light is strongly scattered to produce a large amount of fluorescence. On the side facing the base where the excitation light is strongly scattered, however, the amount of scattered fluorescence also increases, and the optical path length of the fluorescence therefore increases. The fluorescence therefore enters a highly excited state portion of the phosphor (base-side portion).

When a phosphor in the excited state absorbs fluorescence, the following phenomenon occurs: Electrons are re-excited to the conduction band, where no light emission occurs, so that the fluorescence emission efficiency lowers. This phenomenon is called optical quenching. As described above, in the invention disclosed in JP-A-2014-186882 described above, since the fluorescence enters the highly excited state portion of the phosphor, the effect of the optical quenching undesirably increases.

### SUMMARY

An advantage of some aspects of the invention is to provide a wavelength conversion element capable of suppressing the effect of optical quenching with a decrease in light extraction efficiency suppressed. Another advantage of some aspects of the invention is to provide a light source apparatus including the wavelength conversion element. Another advantage of some aspects of the invention is to provide a projector including the light source apparatus.

According to a first aspect of the invention, there is provided a wavelength conversion element including a wavelength conversion layer having a first surface on which excitation light is incident and a second surface provided on a side opposite the first surface, the wavelength conversion layer wavelength-converting the excitation light into light having a wavelength longer than a wavelength of the excitation light, a scattering element contained in the wavelength conversion layer and having a size smaller than or equal to the wavelength of the excitation light, and an angle changing section that changes an angle of incidence of the converted light from the wavelength conversion layer with respect to the first surface or the second surface.

In the wavelength conversion element according to the first aspect, since the excitation light is dominantly scattered in the form of Rayleigh scattering, the converted light is scattered by the scattering element by a small degree. Therefore, since the converted light passes through the wavelength conversion layer in the excited state along a short optical path, the converted light is unlikely to be absorbed, whereby the effect of the optical quenching can be suppressed. Further, since the angle changing section changes the angle of incidence of the converted light with respect to the first or second surface, the converted light is not totally reflected off the first or second surface but can be extracted out of the wavelength conversion layer. A wavelength conversion element that suppresses the effect of the optical quenching with a decrease in the converted light extraction efficiency suppressed can therefore be provided.

In the first aspect described above, it is preferable that in the wavelength conversion layer, a density of the scattering element in a region facing the second surface is higher than the density of the scattering element in a region facing the first surface.

According to the configuration described above, the excitation light is relatively strongly diffused on the side facing the second surface of the wavelength conversion layer, whereby the converted light produced in the region facing the second surface and directed toward the first surface passes through a low excited state density region. The amount of absorbed converted light in the region facing the first surface is therefore reduced, whereby the effect of the optical quenching can be further suppressed.

In the first aspect described above, it is preferable that the wavelength conversion layer contains an activator, and that a concentration of the activator in a region facing the second surface is higher than the concentration of the activator in a region facing the first surface.

According to the configuration described above, in the wavelength conversion layer, a high excited state density region can be formed in a narrow region facing the second surface. As a result, since a large amount of converted light directed toward the first surface exits via the first surface without passing through the high excited state density region, the effect of the optical quenching can be further suppressed.

In the first aspect described above, it is preferable that the wavelength conversion element further includes a first reflection layer that is provided on a side facing the second surface and reflects the converted light, and that the converted light reflected off the first reflection surface exits via the first surface.

According to the configuration described above, a reflective wavelength conversion element that suppresses the effect of the optical quenching with a decrease in the converted light extraction efficiency suppressed can be provided.

In the first aspect described above, it is preferable that the wavelength conversion element further includes a second reflection layer that is provided on a side facing the first surface, transmits the excitation light, and reflects the converted light, and that the converted light reflected off the second reflection layer exits via the second surface.

According to the configuration described above, a transmissive wavelength conversion element that suppresses the effect of the optical quenching with a decrease in the converted light extraction efficiency suppressed can be provided.

According to a second aspect of the invention, there is provided a light source apparatus including the wavelength conversion element according to the first aspect described above and a light source that outputs light toward the wavelength conversion element.

The light source apparatus according to the second aspect, which includes the wavelength conversion element that prevents a decrease in the converted light extraction efficiency and suppresses the effect of the optical quenching, can produce bright illumination light.

According to a third aspect of the invention, there is provided a projector including the light source apparatus according to the second aspect, a light modulator that modulates light from the light source apparatus in accordance with image information to form image light, and a projection system that projects the image light.

The projector according to the third aspect, which includes the light source apparatus according to the second aspect described above, can form a high-luminance image.

### BRIEF DESCRIPTION OF THE DRAWINGS

The invention will be described with reference to the accompanying drawings, wherein like numbers reference like elements.

FIG. 1 shows the configuration of a projector according to a first embodiment.

FIG. 2 shows a schemtic configuration of an illuminator.

FIG. 3 is a cross-sectional view showing the configuration of key parts of a wavelength conversion element.

FIG. 4 is a cross-sectional view showing the configuration of key parts of a wavelength conversion element according to a first variation.

FIG. 5 is a cross-sectional view showing the configuration of key parts of a wavelength conversion element according to a second variation.

FIG. 6 is a cross-sectional view showing the configuration of key parts of a wavelength conversion element according to a third variation.

FIG. 7 is a cross-sectional view showing the configuration of key parts of a wavelength conversion element according to a fourth variation.

FIG. 8 is a cross-sectional view showing the configuration of key parts of a wavelength conversion element according to a second embodiment.

### DESCRIPTION OF EXEMPLARY EMBODIMENTS

Embodiments of the invention will be described below in detail with reference to the drawings.

In the drawings used in the following description, a characteristic portion is enlarged for convenience in some cases for clarity of the characteristic thereof, and the dimension ratio and other factors of each component are therefore not always equal to actual values.

### First Embodiment

An example of a projector according to a first embodiment of the invention will first be descried.

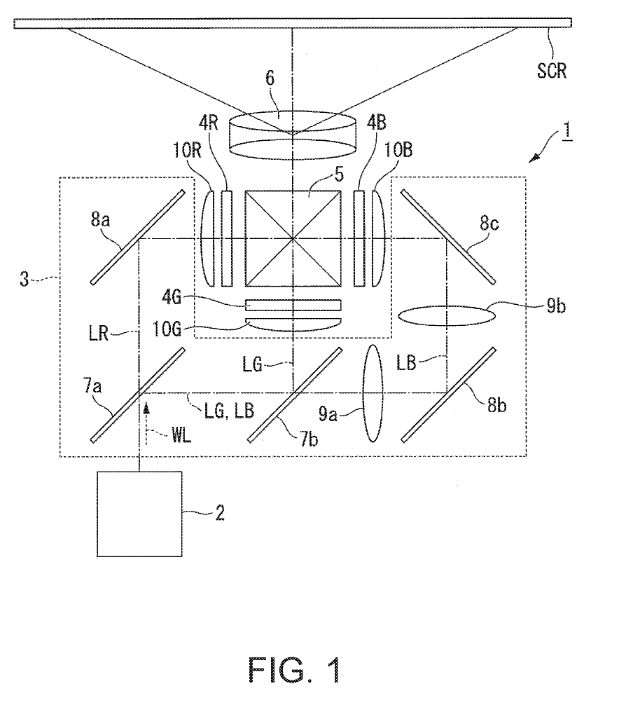

FIG. 1 shows a schematic configuration of the projector according to the present embodiment.

A projector 1 according to the present embodiment is a projection-type image display apparatus that displays color video images on a screen SCR, as shown in FIG. 1. The projector 1 includes an illuminator 2, a color separation system 3, a light modulator 4R, a light modulator 4G, a light modulator 4B, a light combining system 5, and a projection system 6.

The color separation system 3 separates illumination light WL into red light LR, green light LG, and blue light LB. The color separation system 3 generally includes a first dichroic mirror 7a and a second dichroic mirror 7b, a first total reflection mirror 8a, a second total reflection mirror 8b, and a third total reflection mirror 8c, and a first relay lens 9a and a second relay lens 9b.

The first dichroic mirror 7a separates the illumination light WL from the illuminator 2 into the red light LR and the other light (green light LG and blue light LB). The first dichroic mirror 7a transmits the separated red light LR and reflects the other light (green light LG and blue light LB). On the other hand, the second dichroic mirror 7b reflects the green light LG and transmits the blue light LB to separate the other light into the green light LG and the blue light LB.

The first total reflection mirror 8a is disposed in the optical path of the red light LR and reflects the red light LR having passed through the first dichroic mirror 7a toward the light modulator 4R. On the other hand, the second total reflection mirror 8b and the third total reflection mirror 8c are disposed in the optical path of the blue light LB and guide the blue light LB having passed through the second dichroic mirror 7b to the light modulator 4B. The green light LG is reflected off the second dichroic mirror 7b toward the light modulator 4G.

The first relay lens 9a and the second relay lens 9b are disposed in the optical path of the blue light LB and on the downstream side of the second dichroic mirror 7b.

The light modulator 4R modulates the red light LR in accordance with image information to form image light corresponding to the red light LR. The light modulator 4G modulates the green light LG in accordance with image information to form image light corresponding to the green light LG. The light modulator 4B modulates the blue light LB in accordance with image information to form image light corresponding to the blue light LB.

The light modulators 4R, 4G, and 4B are each formed, for example, of a transmissive liquid crystal panel. Polarizers (not shown) are disposed on the light incident side and the light exiting side of each of the liquid crystal panels.

Field lenses 10R, 10G, and 10B are disposed on the light incident side of the light modulators 4R, 4G, and 4B, respectively. The field lenses 10R, 10G, and 10B parallelize the red light LR, the green light LG, and the blue light LB incident on the light modulators 4R, 4G, and 4B, respectively.

The image light fluxes from the light modulators 4R, 4G, and 4B enter the light combining system 5. The light combining system 5 combines the image light fluxes corresponding to the red light LR, the green light LG, and the blue light LB with one another and causes the combined image light to exit toward the projection system 6. The light combining system 5 is formed, for example, of a cross dichroic prism.

The projection system 6 is formed of a projection lens group, enlarges the combined image light from the light combining system 5, and projects the enlarged image light toward the screen SCR. Enlarged color video images are thus displayed on the screen SCR.

### Illuminator

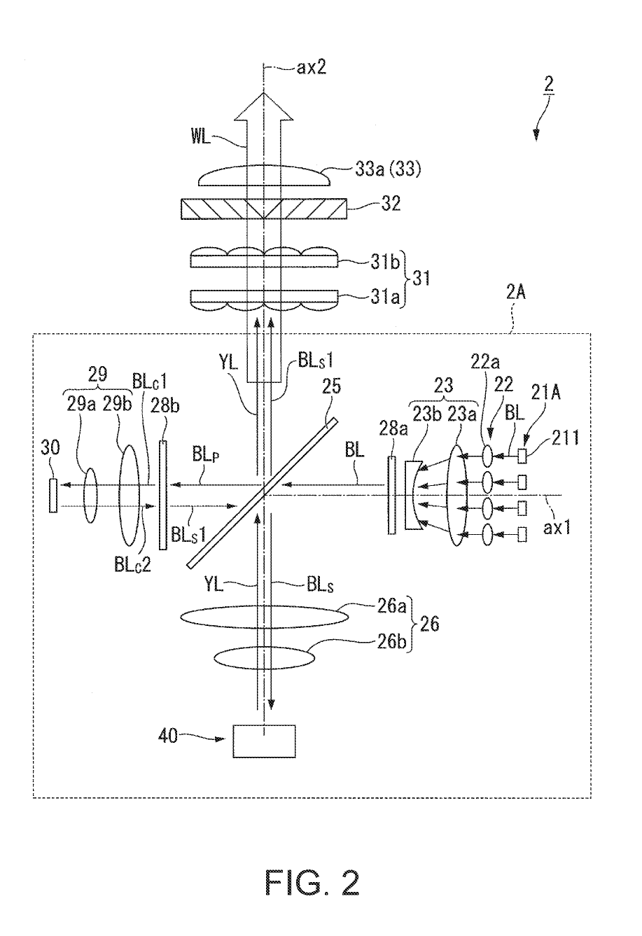

The illuminator 2 will subsequently be described. FIG. 2 shows a schematic configuration of the illuminator 2. The illuminator 2 includes a light source apparatus 2A according to an embodiment of the invention, an optical integration system 31, a polarization conversion element 32, and a superimposing lens 33a, as shown in FIG. 2. In the present embodiment, the optical integration system 31 and the superimposing lens 33a form a superimposing system 33.

The light source apparatus 2A includes an array light source 21, a collimator system 22, an afocal system 23, a first retardation film 28a, a polarization separation element 25, a first light collection system 26, a wavelength conversion element 40, a second retardation film 28b, a second light collection system 29, and a diffusive reflection element 30.

The array light source 21, the collimator system 22, the afocal system 23, the first retardation film 28a, the polarization separation element 25, the second retardation film 28b, the second light collection system 29, and the diffusive reflection element 30 are sequentially arranged along an optical axis ax1. On the other hand, the wavelength conversion element 40, the first light collection system 26, the polarization separation element 25, the optical integration system 31, the polarization conversion element 32, and the superimposing lens 33a are sequentially arranged along an illumination optical axis ax2. The optical axis ax1 and the illumination optical axis ax2 are present in the same plane and perpendicular to each other.

The array light source 21 includes a plurality of semiconductor lasers 21a, which each serve as a solid-state light source. The plurality of semiconductor lasers 21a are arranged in an array in a plane perpendicular to the optical axis ax1.

The semiconductor lasers 21a each output, for example, a blue light beam BL (laser light having intensity that peaks at wavelength of 460 nm, for example). The array light source 21 outputs a light beam flux formed of a plurality of light beams BL. In the present embodiment, the array light source 21 corresponds to the “light source” in the appended claims.

The light beams BL outputted from the array light source 21 enter the collimator system 22. The collimator system 22 converts the light beams BL outputted from the array light source 21 into parallelized light. The collimator system 22 is formed, for example, of a plurality of collimator lenses 22a arranged in an array. The plurality of collimator lenses 22a are disposed in correspondence with the plurality of semiconductor lasers 21a.

The light beams BL having passed through the collimator system 22 enter the afocal system 23. The afocal system 23 adjusts the light flux diameter of each of the light beams BL. The afocal system 23 is formed, for example, of a convex lens 23a and a concave lens 23b.

The light beams BL having passed through the afocal system 23 are incident on the first retardation film 28a. The first retardation film 28a is, for example, a half wave plate configured to be rotatable. The light beams BL outputted from the semiconductor lasers 21a are each linearly polarized light. Appropriately setting the angle of rotation of the first retardation film 28a allows each of the light beams BL having passed through the first retardation film 28a to be a light beam containing an S-polarized component and a P-polarized component with respect to the polarization separation element 25 mixed with each other at a predetermined ratio. The ratio between the S-polarized component and the P-polarized component can be changed by rotating the first retardation film 28a.

The light beams BL each containing the S-polarized component and the P-polarized component produced when the light beam BL passes through the first retardation film 28a are incident on the polarization separation element 25. The polarization separation element 25 is formed, for example, of a polarizing beam splitter having wavelength selectivity. The polarization separation element 25 inclines by 45° with respect to the optical axis ax1 and the illumination optical axis ax2.

The polarization separation element 25 has a polarization separation function of separating each of the light beams BL into a light beam BL_{S}, which is formed of the S-polarized light component with respect to the polarization separation element 25, and a light beam BL_{P}, which is formed of the P-polarized light component with respect to the polarization separation element 25. Specifically, the polarization separation element 25 reflects the light beams BL_{S}, which are each formed of the S-polarized light component, and transmits the light beams BL_{P}, which are each formed of the P-polarized light component.

The polarization separation element 25 further has a color separation function of transmitting fluorescence YL, which belongs to a wavelength band different from the wavelength band to which the light beams BL belong, irrespective of the polarization state of the fluorescence YL.

The S-polarized light beams BL_{S} exited from the polarization separation element 25 enter the first light collection system 26. The first light collection system 26 collects the light beams BL_{S} and directs the collected light beams BL_{S} toward the wavelength conversion element 40.

In the present embodiment, the first light collection system 26 is formed, for example, of a first lens 26a and a second lens 26b. The light beams BL_{S} having exited out of the first light collection system 26 are incident in the form of a collected light flux on the wavelength conversion element 40.

The fluorescence YL produced by the wavelength conversion element 40 is parallelized by the first light collection system 26 and then incident on the polarization separation element 25. The fluorescence YL passes through the polarization separation element 25.

On the other hand, the P-polarized light beams BL_{P} having exited out of the polarization separation element 25 are incident on the second retardation film 28b. The second retardation film 28b is formed of a quarter wave plate disposed in the optical path between the polarization separation element 25 and the diffusive reflection element 30. The P-polarized light beams BL_{P} having exited out of the polarization separation element 25 are converted by the second retardation film 28b, for example, into right-handed circularly polarized blue light BL_{C}1, which then enters the second light collection system 29.

The second light collection system 29 is formed, for example, of a convex lens 29a and a concave lens 29b and causes the collected blue light BL_{C}1 to be incident on the diffusive reflection element 30.

The diffusive reflection element 30 is disposed on the side opposite a phosphor layer 42 with respect to the polarization separation element 25 and diffusively reflects the blue light BL_{C}1 having exited out of the second light collection system 29 toward the polarization separation element 25. The diffusive reflection element 30 preferably not only reflects the blue light BL_{C}1 in a Lambertian reflection scheme but does not disturb the polarization state of the blue light BL_{C}1.

The light diffusively reflected off the diffusive reflection element 30 is hereinafter referred to as blue light BL_{C}2. According to the present embodiment, diffusively reflecting the blue light BL_{C}1 results in blue light BL_{C}2 having a roughly uniform illuminance distribution. For example, the right-handed circularly polarized blue light BL_{C}1 is reflected in the form of left-handed circularly polarized blue light BL_{C}2.

The blue light BL_{C}2 is converted by the second light collection system 29 into parallelized light and then incident on the second retardation film 28b again.

The left-handed circularly polarized blue light BL_{C}2 is converted by the second retardation film 28b into S-polarized blue light BL_{S}1. The S-polarized blue light BL_{S}1 is reflected off the polarization separation element 25 toward the optical integration system 31.

The blue light BL_{S}1 is thus used as the illumination light WL along with the fluorescence YL having passed through the polarization separation element 25. That is, the blue light BL_{S}1 and the fluorescence YL exit out of the polarization separation element 25 in the same direction to form the white illumination light WL, which is the mixture of the blue light BL_{S}1 and the fluorescence (yellow light) YL.

The illumination light WL exits toward the optical integration system 31. The optical integration system 31 is formed, for example, of a lens array 31a and a lens array 31b. The lens arrays 31a and 31b are each formed of a plurality of lenslets arranged in an array.

The illumination light WL having passed through the optical integration system 31 is incident on the polarization conversion element 32. The polarization conversion element 32 is formed of polarization separation films and retardation films. The polarization conversion element 32 converts the illumination light WL containing the non-polarized fluorescence YL into linearly polarized light.

The illumination light WL having passed through the polarization conversion element 32 enters the superimposing lens 33a. The superimposing lens 33a cooperates with the optical integration system 31 to homogenize the illuminance distribution of the illumination light WL in an area illuminated therewith. The illuminator 2 thus produces the illumination light WL.

### Wavelength Conversion Element

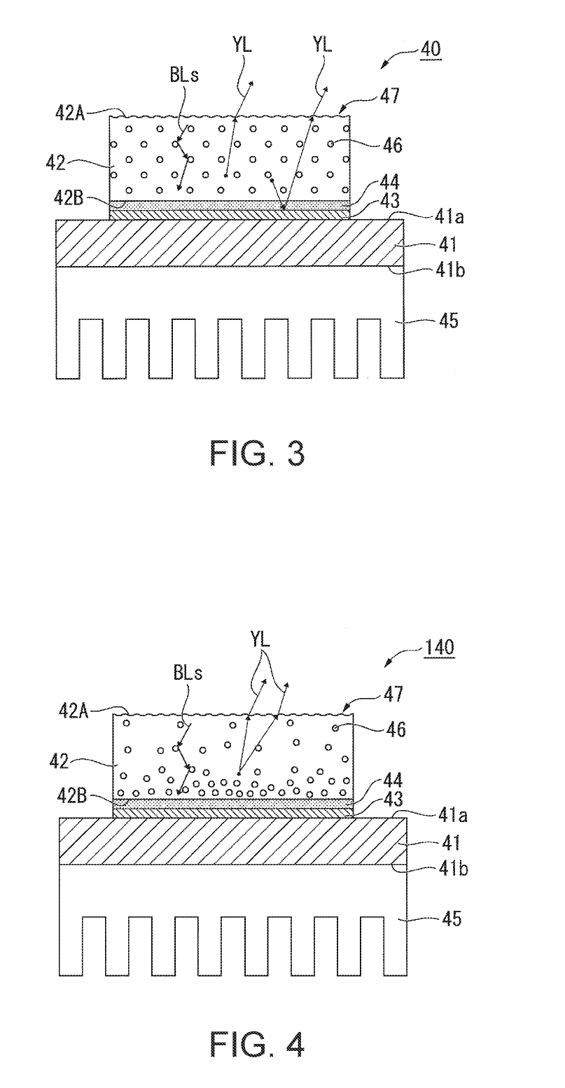

FIG. 3 is a cross-sectional view showing the configuration of key parts of the wavelength conversion element 40.

The wavelength conversion element 40 includes a base 41, a reflection layer 43, a phosphor layer 42, a bonding layer 44, and a heat dissipation member 45, as shown in FIG. 3.

The base 41 has an upper surface 41a, which faces the first light collection system 26, and a lower surface 41b, which is opposite the upper surface 41a. The heat dissipation member 45 is provided on the lower surface 41b of the base 41.

The base 41 is preferably made of a material that has high thermal conductivity and excels in heat dissipation performance. Examples of the material of the base 41 may include aluminum, copper, silver, or any other metal or an aluminum nitride, alumina, sapphire, diamond, or any other ceramic material. In the present embodiment, the base 41 is made of copper.

In the present embodiment, the phosphor layer 42 is held on the upper surface 41a of the base 41 via the bonding layer 44. The phosphor layer 42 converts part of the light incident thereon into the fluorescence YL, which then exits out of the phosphor layer 42. The light beams BL_{S}, which exit out of the first light collection system 26 and enter the phosphor layer 42, are hereinafter referred to as excitation light BL_{S}.

The phosphor layer 42 has an upper surface 42A, on which the excitation light BL_{S} is incident and via which the fluorescence YL exits, and a lower surface 42B, which is provided on the side opposite the upper surface 42A (side facing bonding layer 44). In the present embodiment, the phosphor layer 42 corresponds to the “wavelength conversion layer” set forth in the appended claims, the fluorescence YL corresponds to the “converted light” set forth in the appended claims, the upper surface 42A corresponds to the “first surface” set forth in the appended claims, and the lower surface 42B corresponds to the “second surface” set forth in the appended claims.

In the present embodiment, the reflection layer 43 is formed on the upper surface 41a of the base 41. The reflection layer 43 is formed on the upper surface 41a, for example, in an evaporation process. The reflection layer 43 reflects part of the fluorescence YL traveling toward the upper surface 41a of the base 41 toward the upper surface 42A of the phosphor layer 42. The reflection layer 43 further reflects the excitation light BL_{S} that has not been converted into the fluorescence YL but has exited out of the phosphor layer 42 back into the phosphor layer 42 again. The reflection layer 43 corresponds to the “first reflection layer” set forth in the appended claims.

The bonding layer 44 bonds the base 41 and the phosphor layer 42 to each other. In the present embodiment, the bonding layer 44 is made of a light transmissive material.

The heat dissipation member 44 is formed, for example, of a heat sink and has a structure having a plurality of fins. The heat dissipation member 44 is provided on the lower surface 41b of the base 41, which is the surface opposite the phosphor layer 42. The heat dissipation member 44 is fixed to the base 41, for example, by brazing-metal bonding (metal bonding). Since the wavelength conversion element 40 can dissipate heat via the heat dissipation member 44, thermal degradation of the phosphor layer 42 can be avoided, and a decrease in the conversion efficiency of the phosphor layer 42 due to an increase in the temperature thereof can be suppressed.

In the present embodiment, the phosphor layer 42 is made of a ceramic phosphor formed of fired phosphor particles. A YAG (yttrium aluminum garnet) phosphor containing a Ce ion as an activator (YAG:Ce) is used as the phosphor particles that form the phosphor layer 42. In the present embodiment, the concentration distribution of the activator (Ce ion) is uniform in the phosphor.

The phosphor particles may be made of one material or may be a mixture of particles made of two or more materials. The phosphor layer 42 is preferably, for example, a phosphor layer in which phosphor particles are dispersed in an inorganic binder, such as alumina, or a phosphor layer formed by firing a glass binder, which is an inorganic material, and phosphor particles.

In the present embodiment, the phosphor layer 42 contains a plurality of scattering particles 46. The scattering particles 46 is uniformly distributed in the phosphor layer 42. In the present embodiment, the scattering particles 46 correspond to the “scatter element” set forth in the appended claims.

The scattering particles 46 each have a size smaller than or equal to the wavelength of the excitation light BL_{S}. For example, the scattering particles 46 are formed of pores having an average particle diameter smaller than or equal to 400 nm. The lower limit of the average particle diameter of the scattering particles 46 is desirably, for example, about one-tenth of the wavelength of the blue light beams BL. For example, in the case where the intensity of the blue light beams BL peaks at 460 nm, the average particle diameter of the scattering particles 46 preferably ranges from about 40 to 50 nm.

The scattering particles 46 may be made of a material having a refractive index different from that of YAG, which is the base material of the phosphor layer 42, (for example, alumina, Y₃Al₅O₁₂, YAlO₃, Zirconium dioxide, Lu₃Al₅O₁₂, or glass).

In the present embodiment, since the scattering particles 46 contained in the phosphor layer 42 each have a size smaller than or equal to the excitation light BL_{S}, the excitation light BL_{S} is dominantly scattered in the form of Rayleigh scattering. That is, the excitation light BL_{S} is strongly scattered in the form of Rayleigh scattering. The scattered excitation light BL_{S} is likely to be absorbed because the optical path length thereof lengthens in the phosphor layer 42. That is, since the amount of absorbed excitation light BL_{S} increases, an adequate amount of produced fluorescence YL can be ensured even by a thinner phosphor layer 42. Therefore, since the thickness of the phosphor layer 42 can be reduced, the heat dissipation performance of the phosphor layer 42 is improved, whereby a decrease in the fluorescence conversion efficiency due to an increase in the temperature of the phosphor layer 42 can be suppressed.

When a phosphor in the excited state absorbs fluorescence, the following phenomenon occurs (optical quenching): Electrons are re-excited to the conduction band, where no light emission occurs, so that the fluorescence emission efficiency lowers.

In the present embodiment, the fluorescence YL, which has a wavelength longer than that of the excitation light BL_{S}, is unlikely to be scattered by the scattering particles 46. The fluorescence YL therefore travels roughly straight in the phosphor layer 42 and reaches the upper surface 41A along a short optical path. Therefore, since the fluorescence YL passes through the phosphor layer 42 in the excited state along the short optical path, the fluorescence YL is unlikely to be absorbed, whereby the effect of the optical quenching described above can be suppressed.

Further, in the present embodiment, an irregular section 47 having minute irregularities is formed across the upper surface 42A of the phosphor layer 42. The irregular section 47 is formed by roughening the upper surface 42A. The irregular section 47 is intended to extract the fluorescence YL (cause fluorescence YL to exit) out of the upper surface 42A of the phosphor layer 42. The irregular section 47 corresponds to the “incident angle changing section” set forth in the appended claims.

The effect of the irregular section 47 will now be described. If no irregular section 47 is provided, the fluorescence YL incident on the upper surface 42A at angles greater than the critical angle is totally reflected off the upper surface 42A and directed back into the phosphor layer 42 so that the fluorescence YL cannot exit out of the phosphor layer 42, resulting in a decrease in the efficiency of extraction of the fluorescence YL.

In contrast, the wavelength conversion element 40 according to the present embodiment, which includes the irregular section 47, can change the angle of incidence of the fluorescence YL with respect to the upper surface 42A. That is, even the fluorescence YL incident on the upper surface 42A at an angle greater than the critical angle in the case where no irregular section 47 is formed is incident on the surface of the irregular section 47 at an angle smaller than the critical angle. The fluorescence YL totally reflected off the upper surface with no irregular section 47 formed thereacross passes through the upper surface 42A with the irregular section 47 formed thereacross and exits out of the phosphor layer 42.

Providing the irregular section 47 therefore causes the fluorescence YL to be unlikely to be trapped in the phosphor layer 42, whereby a decrease in the efficiency of extraction of the fluorescence YL can be suppressed.

As described above, the wavelength conversion element 40 according to the present embodiment can suppress the effect of the optical quenching of the fluorescence YL without a decrease in the efficiency of extraction of the fluorescence YL. Further, since the amount of absorbed excitation light BL_{S} increases and the thickness of the phosphor layer 42 can be reduced accordingly, the size of the wavelength conversion element 40 itself can be reduced.

The light source apparatus 2A including the wavelength conversion element 40 therefore prevents a decrease in the efficiency of extraction of the fluorescence YL and suppresses the effect of the optical quenching, whereby the light source apparatus 2A can produce bright illumination light WL. Further, the projector 1 according to the present embodiment, which includes the illuminator 2 using the light source apparatus 2A described above, can form a high-luminance image.

### First Variation

A first variation of the first embodiment will subsequently be described. Components and members common to those in the first embodiment have the same reference characters and will not be described in detail.

FIG. 4 is a cross-sectional view showing the configuration of key parts of a wavelength conversion element 140 according to the present variation.

In the phosphor layer 42 of the wavelength conversion element 140, the density of the scattering particles 46 in a region facing the lower surface 42B is higher than the density of the scattering particles 46 in a region facing the upper surface 42A, as shown in FIG. 4. That is, for example, provided that the scattering particles 46 all have the same size, the above configuration means that the number of scattering particles 46 contained in the region facing the lower surface 42B of the phosphor layer 42 is greater than the number of scattering particles 46 contained in the region facing the upper surface 42A of the phosphor layer 42.

Therefore, in the wavelength conversion element 140 according to the present variation, the excitation light BL_{S} is more strongly scattered in a region closer to the lower surface 42B of the phosphor layer 42. The excitation light BL_{S} that enters the phosphor layer 42 via the upper surface 42A is therefore so scattered that the amount of scattering in the region facing the upper surface 42A is suppressed, and the excitation light BL_{S} hence reaches the region facing the lower surface 42B but a large amount of excitation light BL_{S} is not absorbed in the region facing the upper surface 42A. That is, the fluorescence YL can be efficiently produced because the optical path length of the excitation light BL_{S} in the phosphor layer 42 lengthens.

Also in the present variation, the fluorescence YL is unlikely to be scattered in the phosphor layer 42 and therefore reaches the upper surface 42A along a short optical path. Therefore, since the fluorescence YL passes through the phosphor layer 42 in the excited state along the short optical path, the fluorescence YL is unlikely to be absorbed.

In the present variation, the excitation light BL_{S} is strongly scattered in the region facing the lower surface 42B, as described above. Therefore, in the phosphor layer 42 in the present variation, an excited state density in the region facing the lower surface 42B is higher than the excited state density in the region facing the upper surface 42A, as shown in FIG. 4. The excited state density corresponds to the ratio of the volume of the phosphor particles having absorbed the excitation light BL_{S} to the volume of the phosphor layer 42 (volume density).

Therefore, the fluorescence YL produced in the region facing the lower surface 42B and directed toward the upper surface 42A passes through a low excited state density region, that is, a region having a relatively small number of phosphor particles having absorbed the excitation light BL_{S}. Therefore, the wavelength conversion element 140 according to the present variation, in which the amount of absorbed fluorescence YL is further reduced in the region facing the upper surface 42A, can further suppress the effect of the optical quenching.

### Second Variation

A second variation of the first embodiment will subsequently be described. Components and members common to those in the first embodiment have the same reference characters and will not be described in detail.

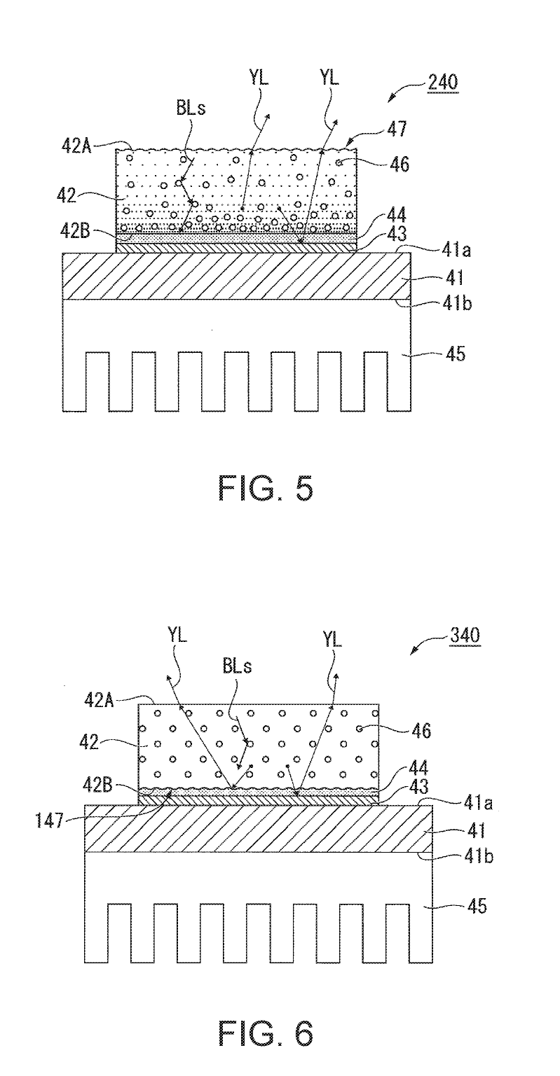

FIG. 5 is a cross-sectional view showing the configuration of key parts of a wavelength conversion element 240 according to the present variation. In FIG. 5, the number of hatched dots represents the magnitude of an activator concentration in the phosphor layer 42. The activator concentration corresponds to the distribution of the concentration of the activator (Ce ion) that occupies the phosphor layer 42.

In the phosphor layer 42 of the wavelength conversion element 240, the concentration of the activator (activator concentration) in the area facing the lower surface 42B is higher than the concentration of the activator in the area facing the upper surface 42A, as shown in FIG. 5.

Further, in the present variation, the density of the scattering particles 46 in the region facing the lower surface 42B is higher than the density of the scattering particles 46 in the region facing the upper surface 42A, as in the first variation.

The wavelength conversion element 240 according to the present variation therefore allows a selective increase in the excited state density in a narrow region facing the lower surface 42B. As a result, since a high excited state density region can be formed on the side facing the lower surface 42B in the phosphor layer 42, a large amount of fluorescence YL directed toward the upper surface 42A exits out of the phosphor layer 42 without passing through the high excited state density region.

As described above, the wavelength conversion element 240 according to the present variation allows reduction in the amount of absorption of the fluorescence YL as compared with the configuration in the first variation, whereby the effect of the optical quenching can be further suppressed.

### Third Variation

A third variation of the first embodiment will subsequently be described. Components and members common to those in the first embodiment have the same reference characters and will not be described in detail.

FIG. 6 is a cross-sectional view showing the configuration of key parts of a wavelength conversion element 340 according to the present variation.

In the present variation, as shown in FIG. 6, an irregular section 147 is formed across the lower surface 42B of the phosphor layer 42. The irregular section 147 is formed by roughening the lower surface 42B.

In the present variation, the irregular section 147 is intended to extract the fluorescence YL (cause fluorescence YL to exit) out of the upper surface 42A of the phosphor layer 42. The irregular section 147 corresponds to the “incident angle changing section” set forth in the appended claims.

The effect of the irregular section 147 will subsequently be described. If no irregular section 147 is provided, part of the fluorescence YL is reflected off the reflection layer 43 and incident on the upper surface 42A at angles greater than the critical angle so that the fluorescence YL is totally reflected into the phosphor layer 42 and does not therefore exit out of the phosphor layer 42.

In contrast, the wavelength conversion element 340 according to the present variation, which includes the irregular section 147 and in which the fluorescence YL is reflected off the surface of the irregular section 147, can change the angle of incidence of the fluorescence YL with respect to the upper surface 42A. Part of the fluorescence YL passes through the lower surface 42B and is reflected off the reflection layer 43 toward the upper surface 42A. The part of the fluorescence YL, when passing through the lower surface 42B, is refracted and the traveling direction of the fluorescence YL therefore changes. Therefore, the fluorescence YL incident on the upper surface 42A at an angle greater than the critical angle in the case where no irregular section 147 is formed is incident on the upper surface 42A at an angle smaller than the critical angle after the fluorescence YL is reflected off the irregular surface of the irregular section 147 or passes through the irregular surface and is then reflected off the reflection layer 43. The fluorescence YL totally reflected off the upper surface 42A in the case where no irregular section 147 is formed passes through the upper surface 42A and exits out of the phosphor layer 42.

Providing the irregular section 147 therefore causes the fluorescence YL to be unlikely to be trapped in the phosphor layer 42, whereby a decrease in the efficiency of extraction of the fluorescence YL can be suppressed.

### Fourth Embodiment

A fourth variation of the first embodiment will subsequently be described. Components and members common to those in the first embodiment have the same reference characters and will not be described in detail.

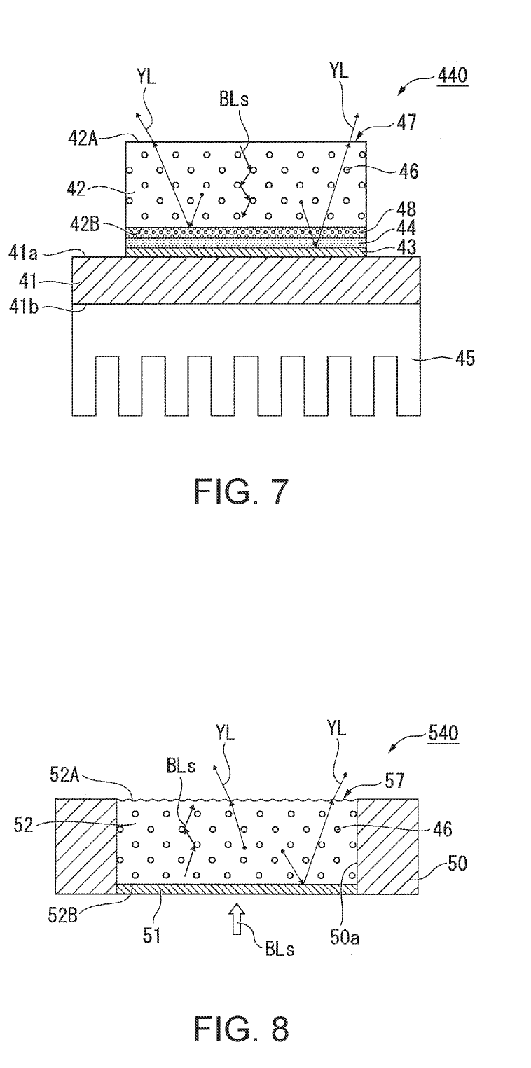

FIG. 7 is a cross-sectional view showing the configuration of key parts of a wavelength conversion element 440 according to the present variation.

The wavelength conversion element 440 according to the present variation includes the base 41, the reflection layer 43, a scattering layer 48, the phosphor layer 42, the bonding layer 44, and the heat dissipation member 45, as shown in FIG. 7.

In the present variation, the scattering layer 48 is formed on the lower surface 42B of the phosphor layer 42. The scattering layer 48 is formed of a porous layer having pores or a layer containing particles having a refractive index different from that of the base material (YAG) of the phosphor layer 42.

In the present variation, the scattering layer 48 is intended to extract the fluorescence YL (cause fluorescence YL to exit) out of the upper surface 42A of the phosphor layer 42. The scattering layer 48 corresponds to the “incident angle changing section” set forth in the appended claims.

The effect of the scattering layer 48 will subsequently be described. If no scattering layer 48 is provided, part of the fluorescence YL is reflected off the reflection layer 43 and incident on the upper surface 42A at angles greater than the critical angle so that the fluorescence YL is totally reflected into the phosphor layer 42 and does not therefore exit out of the phosphor layer 42.

In contrast, the wavelength conversion element 440 according to the present variation, which includes the scattering layer 48 and in which the fluorescence YL is reflected off the scattering layer 48, can change the angle of incidence of the fluorescence YL with respect to the upper surface 42A. Part of the fluorescence YL passes through the scattering layer 48 and is reflected off the reflection layer 43 toward the upper surface 42A. The part of the fluorescence YL, when passing through the scattering layer 48, is refracted and the traveling direction of the fluorescence YL therefore changes. Therefore, the fluorescence YL incident on the upper surface 42A at an angle greater than the critical angle in the case where no scattering layer 48 is formed is incident on the upper surface 42A at an angle smaller than the critical angle after the fluorescence YL is reflected off the scattering layer 48 or passes through the scattering layer 48 and is then reflected off the reflection layer 43. The fluorescence YL totally reflected off the upper surface 42A in the case where no scattering layer 48 is formed passes through the upper surface 42A and exits out of the phosphor layer 42.

Providing the scattering layer 48 therefore causes the fluorescence YL to be unlikely to be trapped in the phosphor layer 42, whereby a decrease in the efficiency of extraction of the fluorescence YL can be suppressed.

### Second Embodiment

A wavelength conversion element according to a second embodiment of the invention will subsequently be described. The wavelength conversion element according to the present embodiment differs from the wavelength conversion element 40 according to the first embodiment in that a light transmissive wavelength conversion element is employed.

FIG. 8 is a cross-sectional view showing the configuration of key parts of a wavelength conversion element 540 according to the present embodiment.

The wavelength conversion element 540 includes a base 50, a dichroic film 51, a phosphor layer 52, and an irregular section 57, as shown in FIG. 8.

In the present embodiment, the phosphor layer 52 is disposed in a through hole 50a provided in the base 50. A reflection film (not shown) is provided on the surface of the through hole 50a.

The phosphor layer 52 has the same configuration as that of the phosphor layer 42 in the first embodiment. Specifically, the phosphor layer 52 has a lower surface 52B, on which the excitation light BL_{S} is incident, and an upper surface 52A, via which the fluorescence YL exits. The phosphor layer 52 contains a plurality of scattering particles 46.

In the present embodiment, the phosphor layer 52 corresponds to the “wavelength conversion layer” set forth in the appended claims, the lower surface 52B corresponds to the “first surface” set forth in the appended claims, and the upper surface 52A corresponds to the “second surface” set forth in the appended claims.

The dichroic film 51 is provided on the lower surface 52B of the phosphor layer 52. The dichroic film 51 transmits the excitation light BL_{S} and reflects the fluorescence YL produced in the phosphor layer 52. The dichroic film 51 corresponds to the “second reflection layer” set forth in the appended claims.

In the wavelength conversion element 540 according to the present embodiment, the excitation light BL_{S} is strongly scattered in the form of Rayleigh scattering. The scattered excitation light BL_{S} is likely to be absorbed because the optical path length thereof lengthens in the phosphor layer 52.

The fluorescence YL, which is unlikely to be scattered by the scattering particles 46, travels roughly straight in the phosphor layer 53 and therefore reaches the upper surface 52A along a short optical path. Therefore, since the fluorescence YL passes through the phosphor layer 52 in the excited state along the short optical path, the fluorescence YL is unlikely to be absorbed, whereby the effect of the optical quenching can be suppressed.

In the present embodiment, the irregular section 57 is formed across the upper surface 52A of the phosphor layer 52. The irregular section 57 is formed by roughening the upper surface 52A. The irregular section 57 is intended to extract the fluorescence YL (cause fluorescence YL to exit) out of the upper surface 52A of the phosphor layer 52. The irregular section 57 corresponds to the “incident angle changing section” set forth in the appended claims.

The wavelength conversion element 540 according to the present embodiment, which includes the irregular section 57, can change the angle of incidence of the fluorescence YL with respect to the upper surface 52A. That is, even the fluorescence YL incident on the upper surface with no irregular section 57 formed thereacross at an angle greater than the critical angle is incident on the surface of the irregular section 57 at an angle smaller than the critical angle. The fluorescence YL totally reflected off the upper surface with no irregular section 57 formed thereacross passes through the upper surface 52A with the irregular section 57 formed thereacross and exits out of the phosphor layer 52.

Providing the irregular section 57 therefore causes the fluorescence YL to be unlikely to be trapped in the phosphor layer 52, whereby a decrease in the efficiency of extraction of the fluorescence YL can be suppressed.

As described above, the wavelength conversion element 540 according to the present embodiment can be a wavelength conversion element capable of suppressing the effect of the optical quenching of the fluorescence YL without a decrease in the efficiency of extraction of the fluorescence YL.

The invention is not limited to the contents of the embodiments described above but can be changed as appropriate to the extent that the change does not depart from the substance of the invention.

For example, the above-mentioned first embodiment has been described with reference to the case where the reflection layer 43 is formed on the upper surface 41a of the base 41, but not necessarily in the invention. That is, the reflection layer 43 may instead be formed on the lower surface 42B of the phosphor layer 42. In this case, the wavelength conversion element 40 has a configuration in which the phosphor layer 42 with the reflection layer 43 formed on the lower surface 42B is bonded to the upper surface 41a of the base 41 via the bonding layer 44.

For example, in the first embodiment described above, in the phosphor layer 42 of the wavelength conversion element 40, the activator concentration in the region facing the lower surface 42B may instead be higher than the activator concentration in the region facing the upper surface 42A.

For example, in the third variation of the first embodiment described above, in the phosphor layer 42 of the wavelength conversion element 340, the activator concentration in the region facing the lower surface 42B may be higher than the activator concentration in the region facing the upper surface 42A, as in the second variation. Further, the density of the scattering particles 46 in the region facing the lower surface 42B may be higher than the density of the scattering particles 46 in the region facing the upper surface 42A.

For example, in the fourth variation of the first embodiment described above, in the phosphor layer 42 of the wavelength conversion element 440, the activator concentration in the region facing the lower surface 42B may be higher than the activator concentration in the region facing the upper surface 42A, as in the second variation. Further, the density of the scattering particles 46 in the region facing the lower surface 42B may be higher than the density of the scattering particles 46 in the region facing the upper surface 42A.

Further, the above-mentioned first embodiment has been described with reference to the case where the light source apparatus according to the embodiment of the invention is incorporated in a projector, but not necessarily. The light source apparatus according to the embodiment of the invention may be used as a lighting apparatus, a headlight of an automobile, and other components.

The entire disclosure of Japanese Patent Application No. 2017-241908, filed on Dec. 18, 2017 is expressly incorporated by reference herein.

What is claimed is:

1. A wavelength conversion element comprising:
a wavelength conversion layer having a first surface on which excitation light is incident and a second surface provided on a side opposite the first surface, the wavelength conversion layer wavelength-converting the excitation light into converted light having a wavelength longer than a wavelength of the excitation light;
a scattering element contained in the wavelength conversion layer and having a size smaller than or equal to the wavelength of the excitation light; and
an incident angle changing section that changes an angle of incidence of the converted light with respect to the first surface or the second surface.

2. The wavelength conversion element according to claim 1,
wherein in the wavelength conversion layer, a density of the scattering element in a region facing the second surface is higher than the density of the scattering element in a region facing the first surface.

3. The wavelength conversion element according to claim 1,
wherein the wavelength conversion layer contains an activator, and
a concentration of the activator in a region facing the second surface is higher than the concentration of the activator in a region facing the first surface.

4. The wavelength conversion element according to claim 1,
further comprising a first reflection layer that is provided on a side facing the second surface and reflects the converted light,
wherein the converted light reflected off the first reflection surface exits via the first surface.

5. The wavelength conversion element according to claim 1,
further comprising a second reflection layer that is provided on a side facing the first surface, transmits the excitation light, and reflects the converted light,
wherein the converted light reflected off the second reflection layer exits via the second surface.

6. A light source apparatus comprising:
the wavelength conversion element according to claim 1; and
a light source that outputs light toward the wavelength conversion element.

7. A light source apparatus comprising:
the wavelength conversion element according to claim 2; and
a light source that outputs light toward the wavelength conversion element.

8. A light source apparatus comprising:
the wavelength conversion element according to claim 3; and
a light source that outputs light toward the wavelength conversion element.

9. A light source apparatus comprising:
the wavelength conversion element according to claim 4; and
a light source that outputs light toward the wavelength conversion element.

10. A light source apparatus comprising:
the wavelength conversion element according to claim 5; and
a light source that outputs light toward the wavelength conversion element.

11. A projector comprising:
the light source apparatus according to claim 6;
a light modulator that modulates light from the light source apparatus in accordance with image information to produce image light; and
a projection system that projects the image light.

12. A projector comprising:
the light source apparatus according to claim 7;
a light modulator that modulates light from the light source apparatus in accordance with image information to produce image light; and
a projection system that projects the image light.

13. A projector comprising:
the light source apparatus according to claim 8;
a light modulator that modulates light from the light source apparatus in accordance with image information to produce image light; and
a projection system that projects the image light.

14. A projector comprising:
the light source apparatus according to claim 9;
a light modulator that modulates light from the light source apparatus in accordance with image information to produce image light; and
a projection system that projects the image light.

15. A projector comprising:
the light source apparatus according to claim 10;
a light modulator that modulates light from the light source apparatus in accordance with image information to produce image light; and
a projection system that projects the image light.
